(19) United States
(12) Patent Application Publication
(10) Pub. No.: US 2014/0142988 A1
(43) Pub. Date: May 22, 2014

(54) SYSTEM AND METHOD FOR ANALYZING PRIVACY BREACH RISK DATA

(71) Applicant: HARTFORD FIRE INSURANCE COMPANY, Hartford, CT (US)

(72) Inventors: Anthony J. Grosso, Suffield, CT (US); Gregory W. Leffard, Newington, CT (US); Jeremiah G. O'Dwyer, Westfield, NJ (US)

(73) Assignee: HARTFORD FIRE INSURANCE COMPANY, Hartford, CT (US)

(21) Appl. No.: 13/683,422

(22) Filed: Nov. 21, 2012

(51) Int. Cl. G06Q 40/08

(52) U.S. Cl. CPC G06Q 40/08
USPC 705/4

(57) ABSTRACT

A risk associated with a data breach of confidential personal data may be determined based on the amount of confidential personal data records stored. Underwriting questions based on the user's business may be determined and transmitted to the user. Input data may be received from a user that is responsive to the underwriting questions. The system may then determine an applicable insurance product with various options and receive a quote for the insurance product and the selected options. The user may initiate the purchase of one insurance product with one or more options, and/or enter into a binding agreement for the purchase of one of the insurance product.

### TECHNICAL FIELD

The subject matter disclosed herein relates to computer systems and data communication systems. More particularly, the subject matter disclosed herein related to the electronic storage, communication, processing, and display of data related to business insurance and other insurance products.

### BACKGROUND

With the increasing necessity to share information among multiple users in multiple locations the increase in formats in which the information can be distributed, organizations storing confidential data are subject to increasing threats placing the data at risk. When creating a corporate infrastructure to store confidential data, a company must consider threats ranging from internal hacks, external hacks, inadvertent disclosure, software malfunction, as well as potential risks from storing information on a third party network.

There are currently a number of federal and state regulations requiring a minimum level of protection for confidential user data. For example, the Health Insurance Portability and Accountability Act (HIPAA) establishes rules and regulations concerning individual's health information. Other regulations exist for an individual's credit information, school records etc.

An insurance underwriter must evaluate the risk associated with the storage of confidential personal data and determine whether to offer coverage to a potential client and to then determine the premium for such coverage. Current models for underwriting a breach of confidential personal data records are almost exclusively based on a company's revenue. However, this does not accurately assess the risks involved. Accordingly, methods and apparatus are required for analyzing privacy breach risk.

### SUMMARY

A system for the processing and display of information related to analyzing privacy breach data risk. The system may include a memory device configured to store a determined risk associated with the storage of confidential personal data, wherein the risk is based on at least the number of records stored by a business. The system may include a processor, operably coupled to the memory device, configured to generate a plurality of underwriting questions, the questions including information concerning total revenue of the business. The system may include a receiver configured to receive a response to the plurality of underwriting questions from the user device and to store the response to the plurality of underwriting questions in the memory device. The processor may further be configured to determine an estimated exposure based at least in part on the determined risk and the response to the plurality of underwriting questions. The processor may further be configured to determine, based on the estimated exposure and the response to the at least one underwriting question, at least one insurance product and at least one coverage option applicable to the business. And the system may include a transmitter configured to transmit information associated with the at least one insurance product to the user device.

### BRIEF DESCRIPTION OF THE DRAWINGS

A more detailed understanding may be had from the following description, given by way of example in conjunction with the accompanying drawings wherein:

FIG. 1 shows an example architecture for communicating, displaying, and processing data related to insurance products;

FIG. 2 shows a flow diagram of an automated underwriting and quoting system related to data breach insurance coverages;

FIG. 3 shows an example web page that includes questions that solicit information from a business owner related to the industries with a business;

FIG. 4 shows a second example web page that includes questions that solicit information from a business owner related to the location of individuals and number of individuals whose confidential personal data is stored by a business;

FIG. 5 shows a third example web page that includes questions that solicit information from a business owner related to the types of data that are stored by a business;

FIG. 6 shows a fourth example web page that includes questions that solicit information from a business owner related to the regulations association a business;

FIG. 7 shows a fifth example of a web page that shows a summary of potential exposure based on the amount of confidential personal data records that have been determined based on the business owner's answers to the questions solicited in FIGS. 3-6;

FIG. 8 shows a fifth example web page that includes question that solicit underwriting information from the business owner;

FIG. 9 shows an example results page that includes a list of recommended products based on the business owner's answer to the questions solicited in FIGS. 3-8;

FIG. 10 shows an example computing device that may be used to implement features described herein with reference to FIGS. 1-9; and

FIG. 11 shows an example cellular phone that may be used to implemented features described herein with reference to FIGS. 1-10.

### DETAILED DESCRIPTION

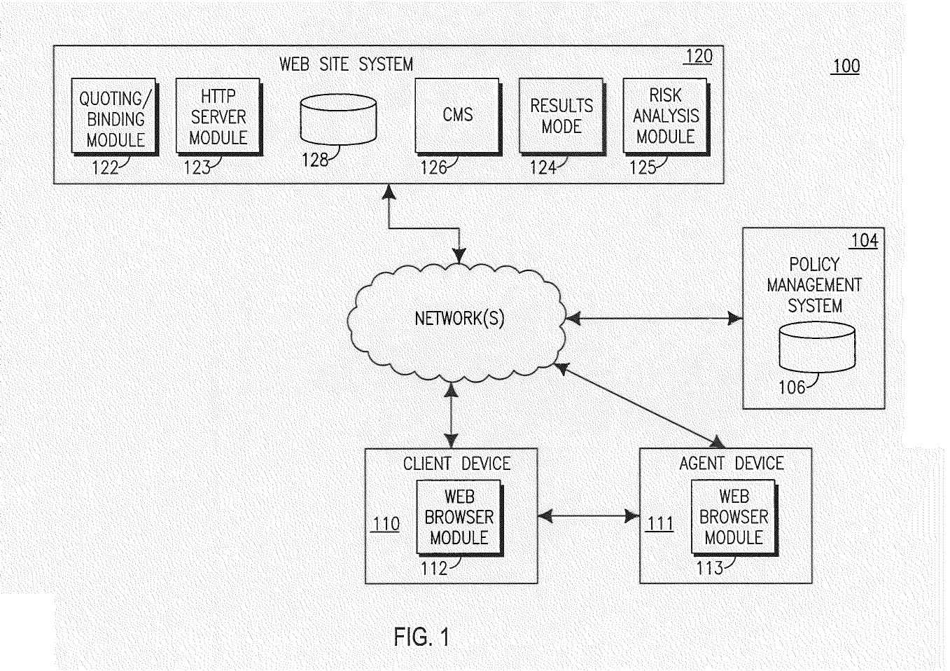

FIG. 1 shows an example architecture 100 for communicating, displaying, and processing data related to data breach insurance products. The example architecture 100 includes a web site system 120, and multiple user devices (including client device 110, an agent device 111), a policy management system 150, and one or more communication networks 102. The web site system 120 may provide access to a web site that is managed by an insurance company. The client device 121 may access the web site via the one or more communication networks 102, and display the web site to a user of the client device 110. The user may be, for example, a business owner. Alternatively, the client device may access the agent device 111, which is operably connected to the web site system 120. The user may also be an agent, speaking to a business owner. In this scenario the information is entered directly from the agent device 111 to the website system 120, The web site may include a page that includes questions of one or more types. As an example, questions of a first type may solicit information regarding specific attributes of the user's business, while questions of a second type may solicit information related to the type and amount of confidential personal data stored by the business insurance. The user may provide information that is responsive to the questions, which may then be transmitted to the web site system 120 by the client device 110. The web site system 120 may then determine, based on the information provided by the user in response to the questions, the insurance products that are applicable to the user's business. The web site system 120 may then transmit additional information back to a user (e.g. client device 110 or agent device 111), related to the applicable products. A user, using the client device 110 or agent device 111 may obtain additional information related to the applicable products, initiate the purchase of an applicable product (by, for example, contacting an agent or employee of the insurance company), and/or enter into a binding agreement for the purchase of an applicable product.

The web site system 120 may include a HyperText Transfer Protocol (HTTP) server module 123, a Content Management System (CMS) 126, a product quoting/binding module 122, a web site database 128, a results module 124, and a risk analysis module 125. The HTTP server module 123 may implement the HTTP protocol, and may communicate HyperText Markup Language (HTML) pages and related data from the web site to/from the client device 110 using HTTP. The HTTP server module 123 may be, for example, an Apache HTTP server, a Sun-ONE Web Server, a Microsoft Internet Information Services (IIS) server, and/or may be based on any other appropriate HTTP server technology.

The web site database 128 may store information that describes and provides the content of the web site. The web site database 128 may be a relational database, a hierarchical database, an object-oriented database, one or more flat files, one or more spreadsheets, and/or one or more structured files. The web site database 128 may be managed by a database management system (not depicted) in the web site system 120, which may be based on a technology such as Microsoft SQL Server, MySQL, PostgreSQL, Oracle Relational Database Management System (RDBMS), a NoSQL database technology, and/or any other appropriate technology. In addition to the page that includes one or more questions that solicit information regarding the user's business, the web site may include one or more Electronic Books (E-Books) that provide information related to the business insurance products offered by the insurance company. Information describing the web pages and the E-Books that constitute the web site may be stored in the web site database 128.

The CMS 126 may be used by administrators of the web site to manage the content of the web site stored in the web site database 128. The CMS 126 may change the content of the web site by adding, deleting, or modifying data in the web site database 128 via the database management system. The CMS 126 may be, for example, a Fatwire system, a Drupal system, a Joomla system, an IBM Lotus Web Content Management system, and/or may be based on any other appropriate CMS technology.

The quoting/binding module 122 may be or include one or more web applications that, in conjunction with the HTTP server module 123, the CMS 126, and/or the policy management system 104, may be used to provide one or more web pages to the client device 110 that provide risk analysis estimates and a price quote for an insurance product offered by the insurance company. Alternatively or additionally, the one or more web applications, in conjunction with the HTTP server module 123, the CMS 126, the risk analysis module 125, and/or the policy management system 104, may be used to enter the user of the client device 110 into a binding agreement for the purchase of an insurance product via the web site.

As described above, the web site system 120 may transmit web pages to the client device 110 that may include one or more questions that solicit information regarding the user's business. This may be performed by, for example, the HTTP server module 123 in conjunction with the CMS 126 and/or the web site database 128. Also as described above, the user may provide information that is responsive to the questions, which may then be transmitted to the web site system 120 by the client device 110. The information may be received via the HTTP server module 123, which may then provide the information to the results module 124 and/or the risk analysis module 125. The results module 124 may determine results information to send back to the client device 110, based on the information that is responsive to the questions. This may include, for example, determining which products are applicable to the user's business, and/or how information related to the applicable products should be displayed. The results module 124, in conjunction with the HTTP server module 123 and/or the CMS 126, may then transmit information back to the client device 110 related to the products that have been determined by the results module 124 as applicable to the user's business. The risk analysis module 125 may determine exposure/liability related to a data breach and send it back to the client device 110, based on the information that is responsive to the questions. This may include, for example, determining, recommended actions under federal regulatory requirements, under trade organization requirements, under state regulatory requirements, under custom contractual requirements. The risk analysis module 125 may also estimate costs for total liability, costs that are insurable, and fines that may be assessed.

The web site system 120 may also include one or more additional components or modules (not depicted), such as one or more load balancers, firewall devices, routers, switches, and devices that handle power backup and data redundancy.

The client device 110 may include a web browser module 112, which may communicate data related to the web site to/from the HTTP server module 123 in the web site system 120 via the one or more communication networks 102. The web browser module 112 may include and/or communicate with one or more sub-modules that perform functionality such as rendering HTML (including but not limited to HTML5), rendering raster and/or vector graphics, executing JavaScript, and/or rendering multimedia content. Alternatively or additionally, the web browser module 112 may implement Rich Internet Application (RIA) and/or multimedia technologies such as Adobe Flash, Microsoft Silverlight, and/or other technologies. The web browser module 112 may implement RIA and/or multimedia technologies using one or web browser plug-in modules (such as, for example, an Adobe Flash or Microsoft Silverlight plugin), and/or using one or more sub-modules within the web browser module 112 itself. The web browser module 112 may display data on one or more display devices (not depicted) that are included in or connected to the client device 110, such as a liquid crystal display (LCD) display or monitor. The client device 110 may receive input from the user of the client device 110 from input devices (not depicted) that are included in or connected to the client device 110, such as a keyboard, a mouse, or a touch screen, and provide data that indicates the input to the web browser module 112. The client device 110 may be, for example, a cellular phone, a laptop computer, a tablet computer, or any other appropriate computing device.

The policy management system 104 may perform functionality such as managing information related to one or more insurance products held by the insurance company. The policy management system 104 may include a product management database 106, which may store information that describe clients of the insurance company and the policies products provided to the clients by the insurance company. The website system 120 may also include the product management database 106. The product management database 106 may be a relational database, a hierarchical database, an object-oriented database, one or more flat files, one or more spreadsheets, and/or one or more structured files. The product management database 106 may be managed by a database management system (not depicted). When a client enters into an agreement for the purchase of a product with the insurance company, information related to the agreement may be added to the product management database 106. Alternatively or additionally, when a user of the client device 110 enters into an agreement for the purchase of a product via the quoting/binding module 122 in the web site system 120, the quoting/binding module 122 may communicate with the policy management system 104, and the product management database 106 may be updated accordingly.

The one or more communication networks 102 in the example architecture 100 may include one or more private Local Area Networks (LANs), and/or one or more public communication networks such as the Internet. The one or more communication networks 102 may be based on wired and/or wireless networking technologies.

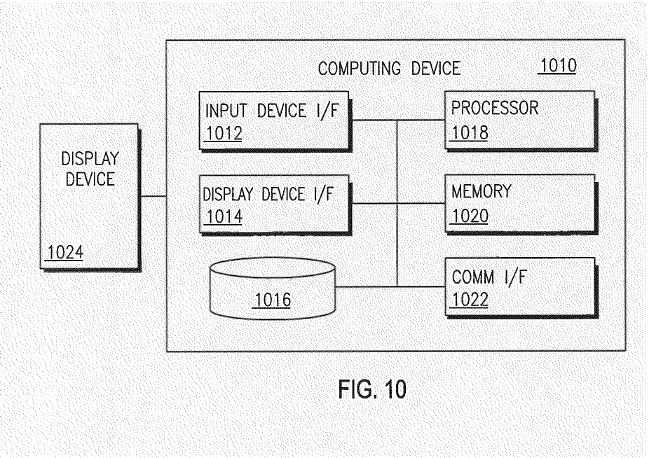

The architecture 100 of FIG. 1 may be implemented using any number of different network topologies and computing devices. For example, each of the quoting/binding module 122, HTTP server module 123, CMS 126, and results module 124 may be implemented using a single computing device, as one or more separate computing devices, or spread across any two or more computing devices, in any combination. Further, the policy management system 104 may be implemented using a single computing device, as one or more separate computing devices, or spread across any two or more computing devices. An example of a computing device that may be used for the implementation of any or any combination of these entities 122, 123, 123, 125, 126, 104 is the computing device 1000 that is described below with reference to FIG. 10. Alternatively or additionally, the client device 110 may be implemented using a computing device such as the computing device 1000 that is described below with reference to Figure 1000 or the cellular phone 1100 described below with reference to 11.

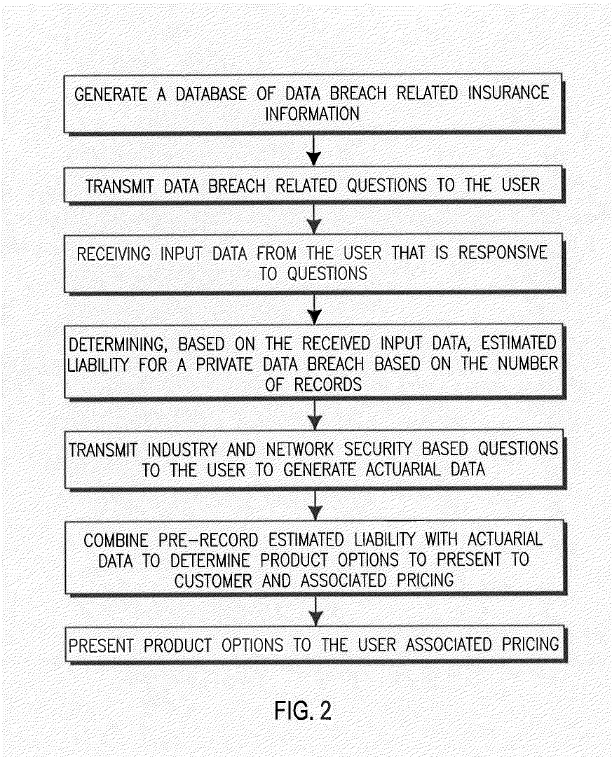

FIG. 2 shows a flow diagram of a method for automated underwriting and quoting data breach related insurance coverages. The method 200 may begin with storing information relating to data breach related insurance coverages 201. This information may be stored in a database and include regulatory information including, but not limited to: fines, mandatory insurance coverages, mandatory procedures, notification costs, and projected costs related to data breaches.

The user may access the database by communicating with the website system 120. The website system 120 transmits questions to the user, which are presented to the user via the web browser module 112, the questions relating to assessing a risk to a business to be insured for data breaches 202. The user may be an agent, accessing the website 120 via an agent device 111. Alternatively, the user may be a potential client, accessing the website 120 directly via a client device 110. Or the user may use a client device 110 to access an agent device 111 which is operably connected to the web site system 120.

The user inputs data, via the web browser module 112, that is responsive to questions related to risks associated with the electronic storage of confidential personal data. The input data from the responses are received by the website system 120 and stored at step 203.

Based on the received input data, the website system 120 then estimates liabilities for one or more data breaches based on the number or confidential personal data records stored 204. The potential liability for data breaches being determined by the system may further be based on at least two or more of: state regulations, fine assessments, historical breach data, and type of business.

The website system 120 then transmits industry and network security questions to the user 205. These questions may request information concerning the type of firewall, antivirus, encryption and other security measures implemented at the business. Additionally, the questions may include other security based questions. This information is used to generate actuarial data.

The website system 120 implements a software-based algorithm to determine whether to underwrite the business. And, to determine product options to present to the customer along with pricing 206.

The website system 120 then presents the product options and associated pricing to the user 207.

The user may enter additional input data after which the system may receive the additional input data that binds the user to one or more of the selected data breach related insurance coverages.

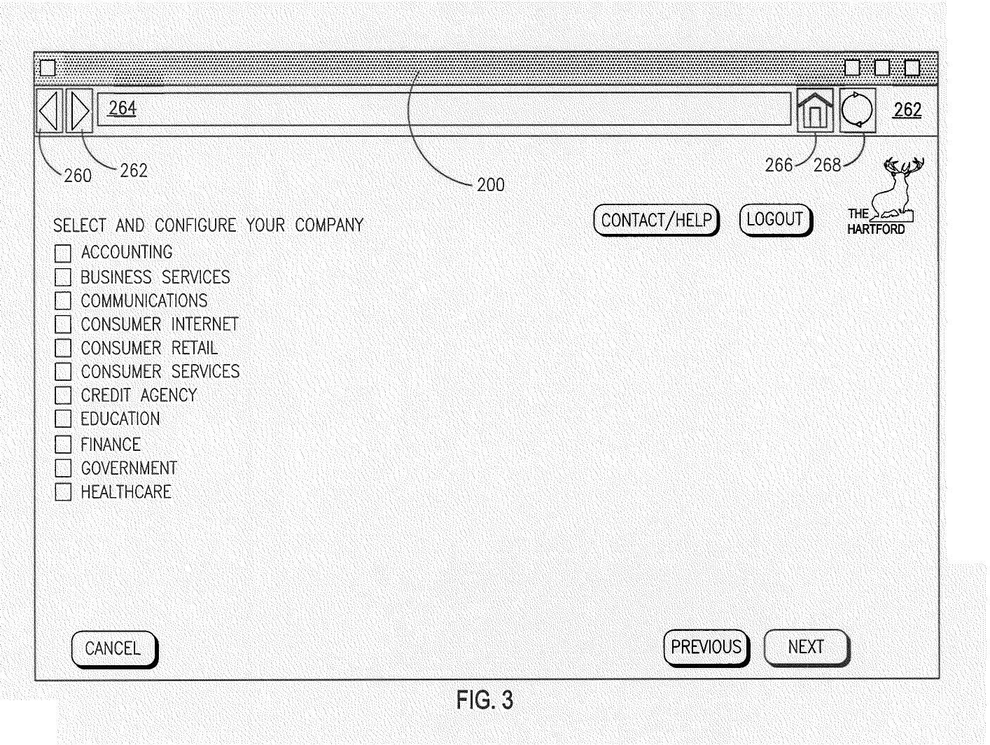

FIGS. 3-9 show example web pages that may be displayed by the web browser module 112. As will be described in detail below, the web pages may include display elements which prompt the user of the client device 110 for information about the user's business in order to perform a cyber risk assessment. The web pages may be included in a web browser window 200 that is displayed and managed by the web browser module 112. The web pages may include data received by the web browser module 112 from the web site system 120. The web pages may include information related to products sold by the insurance company, information related to clients that have purchased products sold by the insurance company, and other related information.

The web browser window 200 may include a control area 262 that includes a back button 260, forward button 262, address field 264, home button 266, and refresh button 268. The control area 262 may also include one or more additional control elements (not depicted). The user of the client device 110 may select the control elements 260, 262, 264, 266, 268 in the control area 262. The selection may be performed, for example, by the user clicking a mouse or providing input via keyboard, touch screen, and/or other type of input device. When one of the elements 260, 262, 264, 266, 268 is selected, the web browser module 112 may perform an action that corresponds to the selected element. For example, when the refresh button 268 is selected, the web browser module 112 may refresh the page currently viewed in the web browser window 200.

As shown in FIG. 3, the web page 202 may include an industries area 230, a cancel button 232, a previous button 234, and a next button 236. The industries area 230 may include a list of potential industries in which the business owner operates. As shown in FIG. 3 each of the listed industries has a radio button associated with it. The business owner can select the radio button to indicate industries that are applicable to their business. Alternatively, the industries are 230 may be represented in a drop down list (not shown).

As the user provides input into the input field 230, the web browser module 112 may store one or more data structures (“response data”) that reflect the selections made in the input fields 230 and 238. Further, as the selections are updated, the web browser module 112 may update the industries area 230 to indicate additional or more specific industry designations that may be associated match the selections. As an example, only twenty five (25) industries are listed, a business owner may select the radio button corresponding to “Other” which may generate a list of miscellaneous industries to be shown in the industries area 230. For example, the business owner may select a radio button associated with the communications industry in the industries area 230; the web browser module 112 may then update webpage 202 to request further information about the selected industry with additional radio buttons specific to the communications industry (e.g. cellular communications, landline communications, computer network communications etc.).

At any time, while viewing the webpage 202 of FIG. 3, the user may select the cancel button 232, which cancels any pending action and returns the user to a homepage (not shown). Selecting the previous button 234 allows the user to return to the previous screen, while remaining in a session. Selecting the next button 236 enters the selections which are then transmitted to the website system 120. If there are no errors in the transmission, the web browser module 112 is directed to a subsequent web page.

Alternatively or additionally, if the user arrives at the web site managed by the web site system 120 via a search engine, the profiles displayed in the industry area 230 may be determined based on the search terms that were used to arrive at the web site. For example, if the user had used a search term that relates to a given industry, the industry area 230 may include a preselected radio button or a highlighted industry that relate to clients whose businesses are in the given industry.

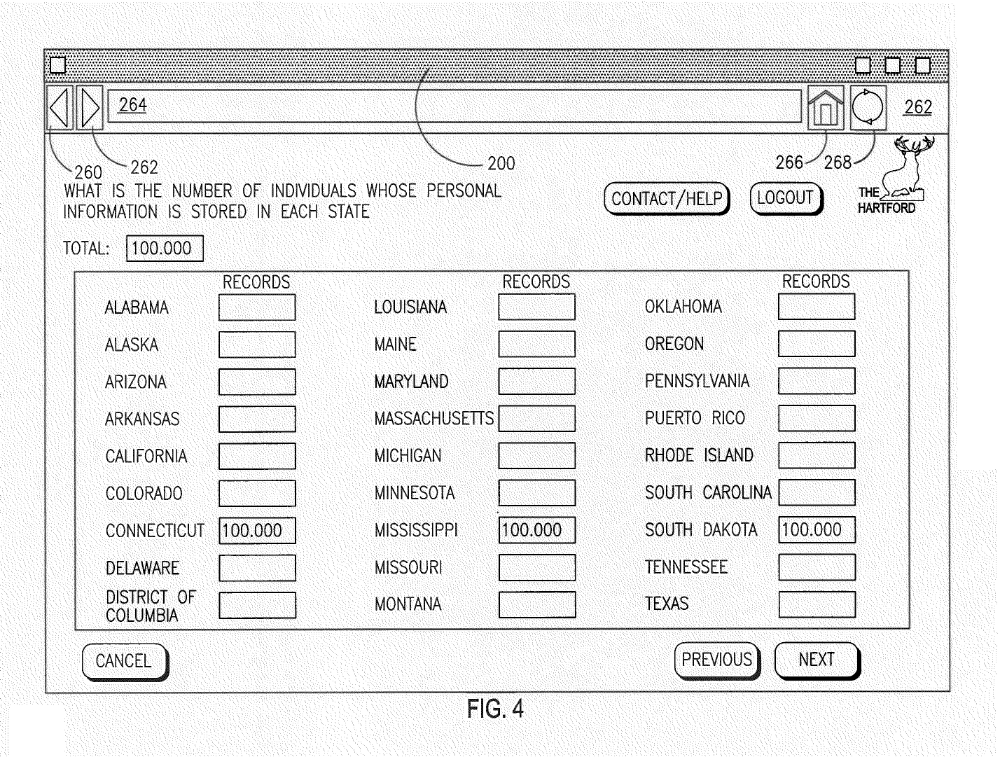

FIG. 4 shows the data record calculation screen. Because each jurisdiction may have different confidential personal data breach regulations the user is provided with questions soliciting a response from the user of the client device 110 regarding the locations associated with the confidential personal data records. Once a business owner has selected the next button 236 on web page 302, the user is taken to web page 402. In accordance with one embodiment, the web browser module 112 requests information from the business owner regarding the number personal records stored. The web page 402 includes input fields to quantify the amount of confidential personal data records stored by the business. As shown in FIG. 4, the user is presented with a plurality of input fields (collectively input fields 464) in which the user may enter the number of lost records per jurisdiction.

At any time, while viewing the webpage 402 of FIG. 4, the user may select the cancel button 432, which cancels any pending action and returns the user to a homepage (not shown). Selecting the previous button 434 allows the user to return to the previous screen (e.g. web page 302), while remaining in a session. Selecting the next button 436 enters the selections which are then transmitted to the website system 120. If there are no errors in the transmission, the web browser module 112 is directed to a subsequent web page.

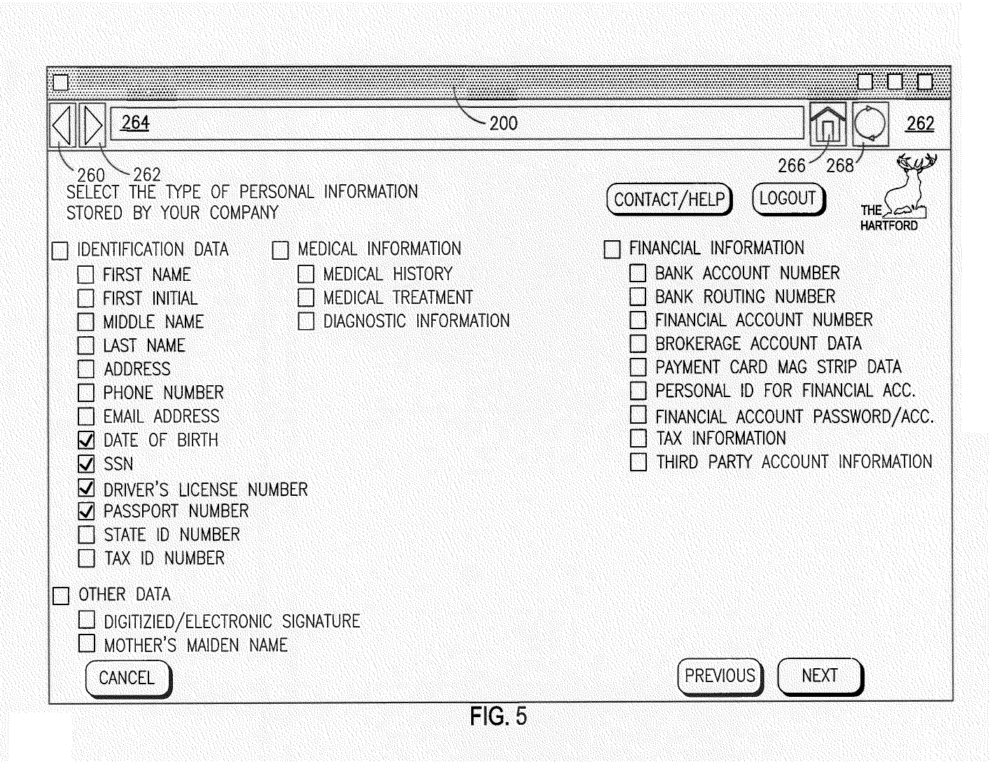

Referring now to FIG. 5, FIG. 5 shows a web page 502 after the user has selected entered information to webpage 402 and submitted the selection via the next button 436. FIG. 5 shows a web page 502 for selection of the data types stored by the business owner. Businesses may store data of different types, for example, several types of data shown in web page 502 for example, identification data 551, medical information 552, financial information data 553, or other such types of data 554. While specific data types are shown in web page 402, the actual data types may vary based on the user's selection from web pages 302 and 402.

As shown in FIG. 5 the user is requested to select which types of data are being stored. The business owner is presented with radio buttons next to each type of data in the data type area 551-554to select which data types apply to their business. For example, if the business owner's records store only personal information, the business owner can select the radio button associated with each individual type of personal information in the identification data field 551 (i.e. date of birth, social security number, driver's license number, and/or passport number), or the business owner may select the radio button associated with identification information and the web browser module 112 will select all fields in the personal information area 252.

At any time, while viewing the webpage 502 of FIG. 5, the user may select the cancel button 532, which cancels any pending action and returns the user to a homepage (not shown). Selecting the previous button 534 allows the user to return to the previous screen (e.g. web page 402), while remaining in a session. Selecting the next button 536 enters the selections which are then transmitted to the website system 120. If there are no errors in the transmission, the web browser module 112 is directed to a subsequent web page.

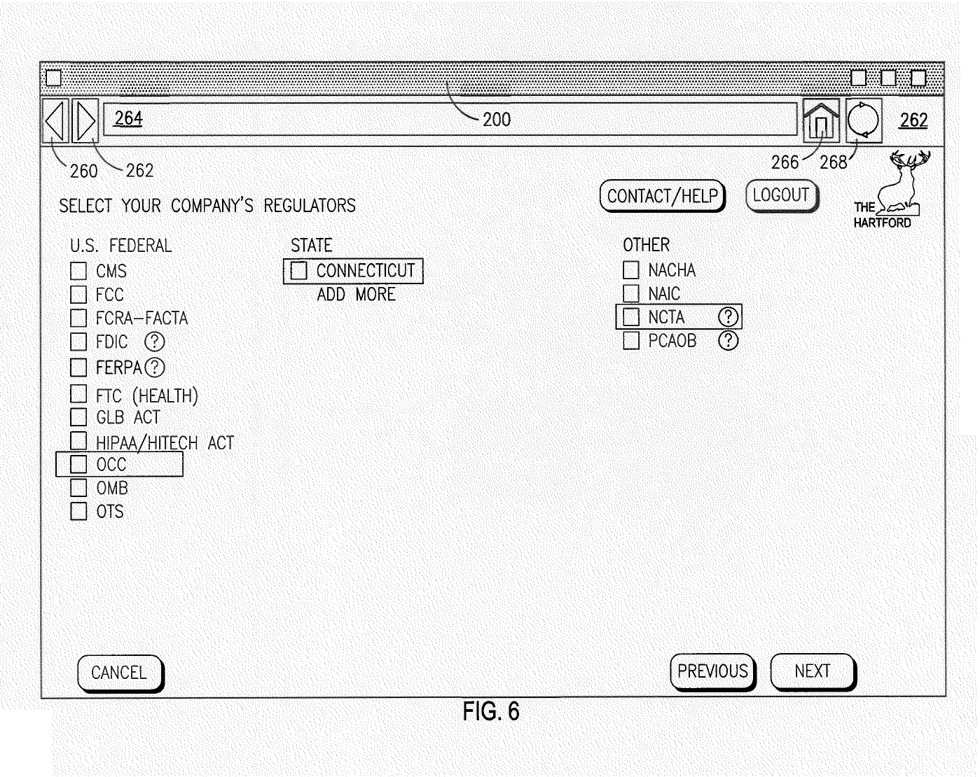

Referring now to FIG. 6, FIG. 6 shows the web page 602 after the user has selected entered information to webpage 502 and submitted the selection via the next button 536. The regulators area 644 includes a list of regulators which may apply to the business owner's selected industry. As shown in FIG. 6, the regulatory bodies are listed in groups, including Federal Regulatory Bodies, State, and other. Each regulator in the regulators area 644 has a radio button associated with it. Based on the user's selections on the previous web pages, the website browser module 112 will highlight the predetermined regulators that may be associated with the selected industry. The business owner may then select the highlighted regulation by selecting the corresponding radio button or they may select any other regulation which they believe apply.

As shown in FIG. 6, based on the previously submitted selections, the web browser module 112 shows highlighted regulators in the regulators area 644 that are recommended for the business owner. The user has the option to select the regulators that are appropriate. As shown by example in 6, the user may have previously notified the website system 120 that the confidential personal data records stored by the business may be limited to Connecticut. Accordingly, the web browser module 112 has included Connecticut as an option to select in regulators area 644. The user may select the “add more” button in regulators area 644 to add other states. Some regulators may be highlighted and the radio button may be preselected. Further, in response to the selection, the web browser module 112 may analyze which regulators relate to the selected industry, and update the list in the regulators area 644 accordingly.

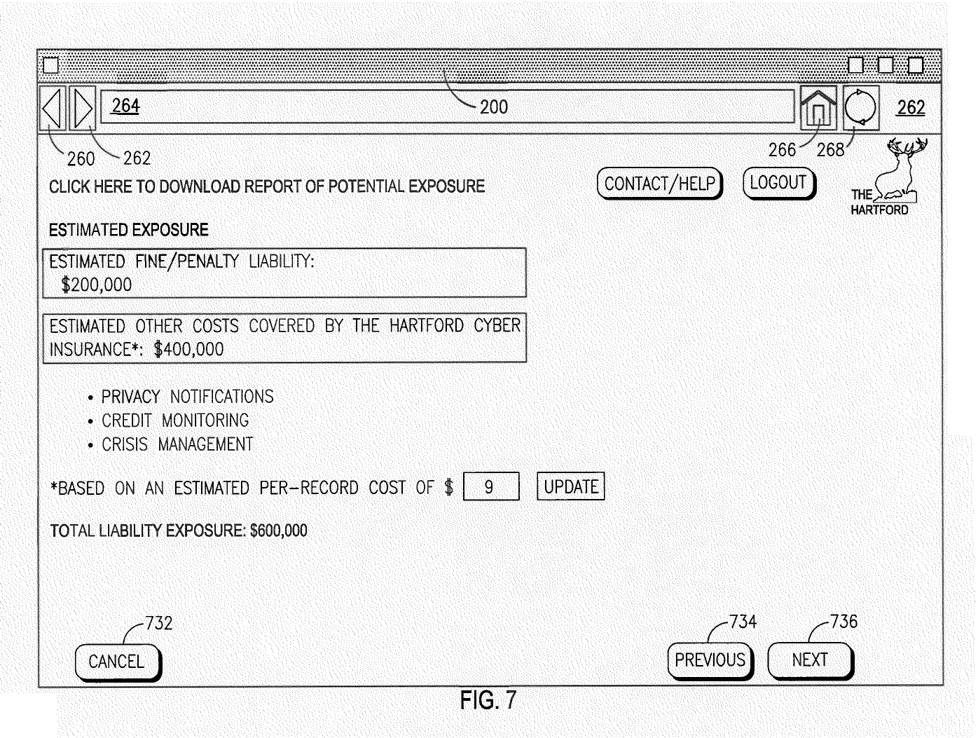

FIG. 7 shows the webpage 702 including a risk assessment requested based on information provided by the user. The risk assessment may be presented directly to the business owner, via web browser module 112 or alternatively may be presented directly to the agent device 111 along with some type of alert. Web page 702 provides the user with information relating to the types of exposure the insurance company may be subjected to. Web page 702 includes estimated costs field as determined by the risk analysis module 125. Web page 702 further includes an estimated cost per record field, which determines exposure data loss event as a function of the total number of confidential personal data records stored by the company. The results web page 702 further includes a total liability, which is based on the sum of estimated exposures.

While the embodiments above describe the determination of the estimated per-record liability as being performed by the risk analysis module 125, it may also be produced by a third party system and transmitted to the web site system 120.

At any time, while viewing the webpage 702 of FIG. 7, the user may select the cancel button 732, which cancels any pending action and returns the user to a homepage (not shown). If the “click here to download report of potential exposure” link is selected, the web browser module 112 may transmit the question response data (which may be based on user input, as described above) to the web site system 120. This may include, for example, the web browser module 112 transmitting information related to the question response data to the HTTP server module 123. For example, the web browser module 112 may send one or more HTTP GET or POST messages to the HTTP server module 123 that include one or more parameters that include the question response data. The HTTP server module 123 may then provide the question response data to the risk analysis module 125.

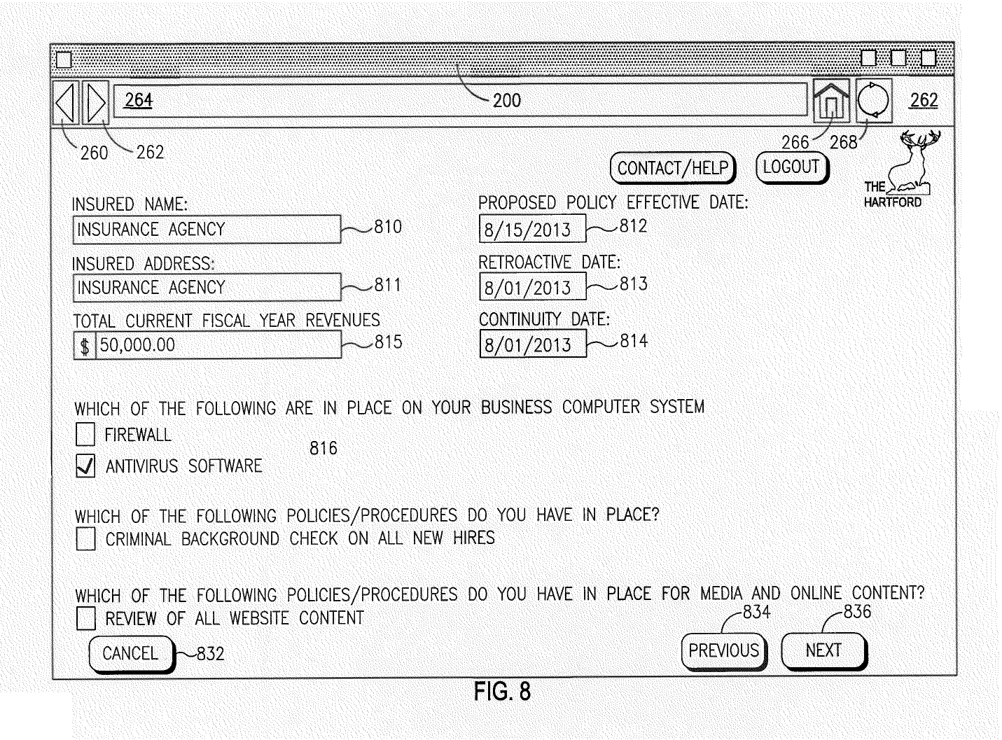

Referring now to FIG. 8, FIG. 8 shows the underwriting information collection web page 802 after the user has reviewed the information on webpage 702 and accepted the information by selecting the next button 736. As shown in FIG. 8, there are multiple input fields 810-815 requesting additional underwriting information related to the business. This information may include the business name, address, revenues, and the dates for which a policy is requested. Web page 802 also includes input area 816 which requests information concerning the businesses security policies and operating procedures. Based on the information provided by the user, the risk analysis module 125 may determine questions to present to the user in input area 816. For example, if the business has employees, the web page module 112 may present the user with questions concerning employee training policies. Each selection in input area 816 is shown with a radio button to allow the user to enter a selection via web browser module 112. Once the user has completed the information, they may select the next button 836 and submit the information to web site 120.

Based on the exposure information and the underwriting information, the risk analysis module 125 may then generate risk and liability data for the insurance company. The results module 124, in conjunction with the HTTP server module 123 and/or the CMS 126, may then generate information that describe a results web page, and send the information to web browser module 112 in the client device 110 using an HTTP response that is responsive to the receive HTTP GET or POST described above.

In addition to the question response data, the web browser module 112 may obtain data obtained directly from other modules (not depicted) in the client device 110, without input from the user of the client device 110. This may include, for example, location information that may be obtained from a Global Positioning System (GPS) module (not depicted) in the client device 110, and/or other data. This additional information may be transmitted by the web browser module 112 along with the question response data that is sent to the results module 124. The results module 124 may use this additional data in determining whether a product is available to a user, determining product relevance, and/or determining how the results web page that includes the information related to the products should appear.

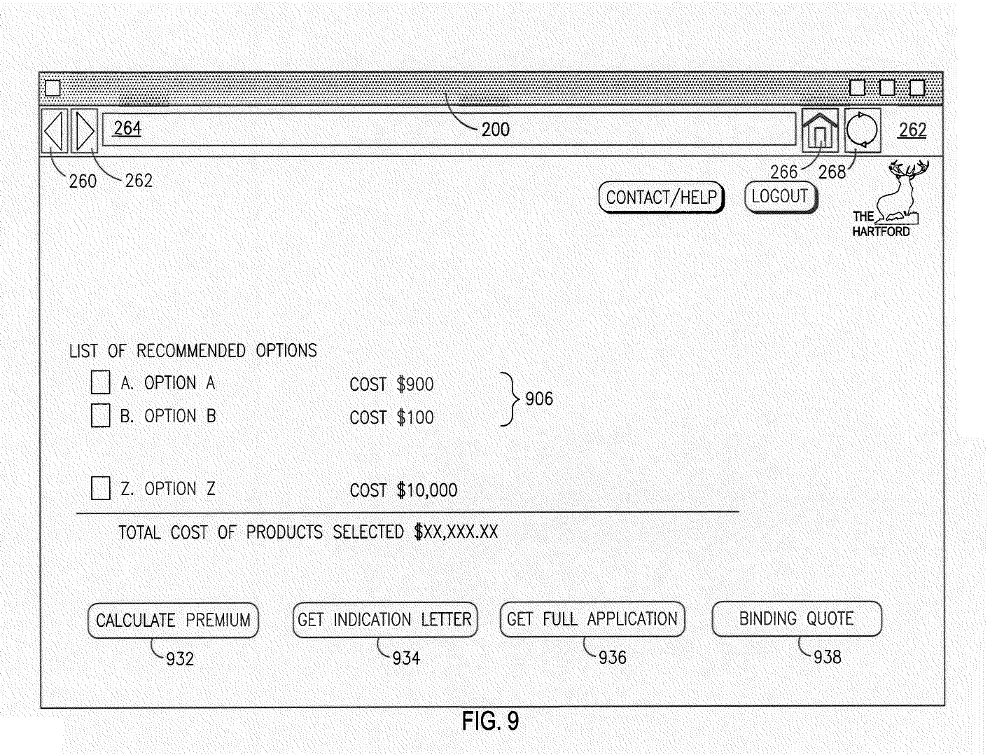

FIG. 9 shows an example results web page 902 that includes information generated by the results module 124 and that risk analysis module 125, and which may be displayed by the web browser module 112. According to the example of FIG. 9, the results module 124 determined the contents of the example results web page 902 based on question response data, and the information that describes the contents of the example results web page 902 was received by the web browser module 112. The results web page 902 includes a list of recommended options 906 and price quotes based at least on the exposure associated with the amount of data records and the risk determined based on the responses to the underwriting questions. The options may be individual options, and/or may include “bundle” options. A bundle option may be an aggregate of two or more options, or may be a recommended grouping of two or more individual options. The options may include, for example, data privacy liability coverage, network security liability coverage, e-media liability coverage, notification expense and credit monitoring expense, crisis management expense, data privacy and regulatory expense, and cyber investigation expense.

When either of the radio buttons associated with the options in the options field 906 are selected, the web browser module 112 may generate one or more data structures that reflect the values indicated. The web browser module 112 may then transmit the data to the web site system 120. The results module 124 may then receive the data, and process the data in the same way that the results module 124 processes question response data, as described above. The web site system 120 may then transmit a new results page to the web browser module 112. The new results page may have a similar or identical format to the results web page 902 shown in FIG. 9 adding an updated total cost of the products. The web browser module 112 may display the new results page in the web browser window 200.

The user may calculate the premium using button 932. Alternatively the user may request an indication letter using button 934. The user may request a full application using button 936. Or, the user may request a binding quote using button 938. After receiving the binding quote, the user may submit a bid accepting the costs. If the user submits a bid accepting the costs, the web browser module 112 may interact with the quoting/binding module 122 and/or the policy management system 104, and enter into a binding agreement to purchase an insurance product from the insurance company. Information related to the user's business may be communicated to the quoting/binding module 122 and/or the policy management system 104, to facilitate obtaining the quote or the purchase of the insurance product. Alternatively or additionally, in response to a user input in one of the previous web pages, the web browser module 112 may navigate to a web page that has contact information (such as a phone number and/or email address) for an employee or agent of the insurance company. The user may then contact the employee/agent via phone and/or email, and initiate the purchase of a product from the insurance company. Alternative or additionally, in response to a user input, the web browser module 112 may navigate to a web page within the web site of the insurance company that provides more information related to the product that corresponds to the recommended products 706.

FIG. 10 shows an example computing device 1010 that may be used to implement features describe above with reference to FIGS. 1-9. The computing device 1010 may include a processor 1018, memory device 1020, communication interface 1022, input device interface 1012, display device interface 1014, and storage device 1016. FIG. 10 also shows a display device 1024, which may be coupled to or included within the computing device 1010.

The memory device 1020 may be or include a device such as a Dynamic Random Access Memory (D-RAM), Static RAM (S-RAM), or other RAM or a flash memory. The storage device 716 may be or include a hard disk, a magneto-optical medium, an optical medium such as a CD-ROM, a digital versatile disk (DVDs), or Blu-Ray disc (BD), or other type of device for electronic data storage.

The communication interface 1022 may be, for example, a communications port, a wired transceiver, a wireless transceiver, and/or a network card. The communication interface 1022 may be capable of communicating using technologies such as Ethernet, fiber optics, microwave, xDSL (Digital Subscriber Line), Wireless Local Area Network (WLAN) technology, wireless cellular technology, and/or any other appropriate technology.

The input device interface 1012 may be an interface configured to receive input from an input device such as a keyboard, a mouse, a trackball, a touch screen, a touch pad, a stylus pad, and/or other device. The input device interface 1012 may operate using a technology such as Universal Serial Bus (USB), PS/2, Bluetooth, infrared, and/or other appropriate technology.

The display device interface 1014 may be an interface configured to communicate data to display device 1024. The display device 1024 may be, for example, a monitor or television display, a plasma display, a liquid crystal display (LCD), and/or a display based on a technology such as front or rear projection, light emitting diodes (LEDs), organic light-emitting diodes (OLEDs), or Digital Light Processing (DLP). The display device interface 1014 may operate using technology such as Video Graphics Array (VGA), Super VGA (S-VGA), Digital Visual Interface (DVI), High-Definition Multimedia Interface (HDMI), or other appropriate technology. The display device interface 1014 may communicate display data from the processor 1018 to the display device 1024 for display by the display device 1024. As shown in FIG. 10, the display device 1024 may be external to the computing device 1010, and coupled to the computing device 1010 via the display device interface 1014. Alternatively, the display device 1024 may be included in the computing device 1000.

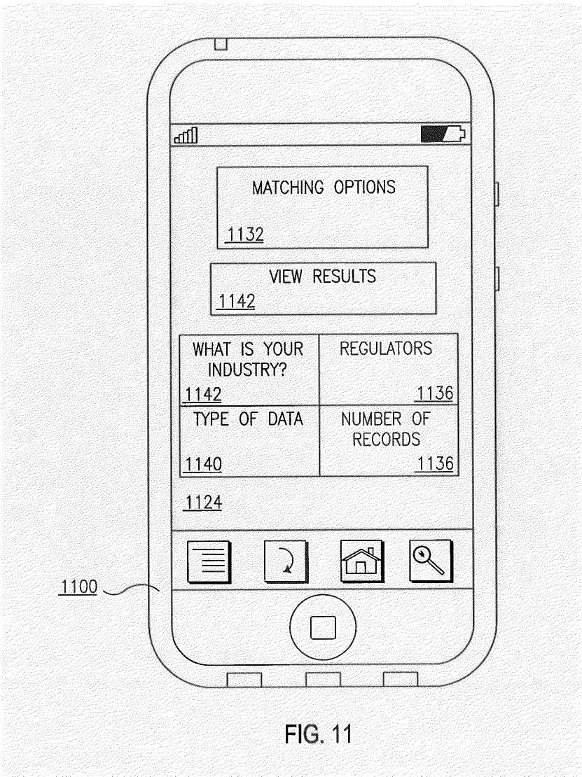

An instance of the computing device 1010 of FIG. 10 may be configured to perform any feature or any combination of features described above as performed by the client device 110. In such an instance, the memory device 1020 and/or the storage device 1016 may store instructions which, when executed by the processor 1018, cause the processor 1018 to perform any feature or any combination of features described above as performed by the web browser module 112. In such an instance, the computing device 1010 may be, for example, a laptop computer, a tablet computer, a desktop computer, cellular phone (such as but not limited to the cellular phone 1100 described below with reference to FIG. 11), a personal digital assistant (PDA), or any other appropriate computing device.

Alternatively or additionally, an instance of the computing device 1010 may be configured to perform any feature or any combination of features described above as performed by the quoting/binding module 122, HTTP service module 124, CMS 126, and/or results module 124. In such an instance, the memory device 1020 and/or the storage device 1016 may store instructions which, when executed by the processor 1018, cause the processor 1018 to perform any feature or any combination of features described above as performed by the quoting/binding module 122, HTTP server module 123, CMS 126, results module 124, and/or the risk analysis module 125. In such an instance, the computing device 1010 may be a server computer or any other appropriate computing device.

Further, an instance of the computing device 1010 may be configured to perform any features or combination of features described above as performed by the policy management system 104. In such an instance, the memory device 1020 and/or the storage device 1016 may store instructions which, when executed by the processor 1018, cause the processor 1018 to perform any feature or any combination of features described above as performed by the policy management system 104. In such an instance, the computing device 1010 may be a server computer or any other appropriate computing device.

FIG. 11 shows a cellular phone 1100 that is a more specific example of the computing device 1000 described above with reference to FIG. 10. The cellular phone may include a touch screen 1124, and may also include a processor (not depicted), memory device (not depicted), communication interface (not depicted), input device interface (not depicted), display device interface (not depicted), and storage device (not depicted), which may possess characteristics of processor 1018, memory device 1020, communication interface 1022, input device interface 1012, display device interface 1014, and storage device 1016 described above with reference to FIG. 10. The touch screen 1124 is a more specific example of the display device 1024 described above with reference to FIG. 10, and may be based on technology such as, for example, LCD, LED, and/or other appropriate display technology. The touch screen 1124 may receive user input using technology such as, for example, resistive sensing technology, capacitive sensing technology, optical sensing technology, or any other appropriate touch-sensing technology. The touch screen 1124 may provide user input data to the input device interface (not depicted) in the cellular phone 1100. The communication interface (not depicted) in the cellular phone may be a wireless transceiver, and may be capable of communicating using wireless technology such as Long Term Evolution (LTE), LTE-Advanced (LTE-A), Universal Mobile Telecommunications System (UMTS), IEEE Institute of Electrical and Electronics Engineers (IEEE) 802.16/WiMax, IEEE 802.16m, Wireless Broadband (WiBro), Global System for Mobile Communications (GSM), Enhanced Data Rates for GSM Evolution (EDGE) Radio Access Network (GERAN), Code Division Multiple Access 2000 (CDMA2000), and/or any other appropriate wireless technology.

The touch screen 1124, as shown in FIG. 11, may display a matching products area 1132, first input field 1134, a second input field 1136, a third input field 1138, a fourth input field 1140, and a view results button 1142. As described above with reference to FIG. 10, the processor in the cellular phone 1000 may execute instructions which cause the processor to perform the functionality described above as performed by the web browser module 112. This may include displaying the display elements 1132, 1134, 1136, 1138, 1140, 1142 in the touch screen 1124, as shown in FIG. 11. These display elements 1132, 1134, 1136, 1138, 1140, 1142 may display similar data and receive user input in a similar fashion as that described above with respect to the corresponding display elements of FIGS. 3-9. A user of the cell phone 1100 may interface with these display elements 1132, 1134, 1136, 1138, 1140, 1142 by using the touch screen 1124.

Although examples are provided above with reference to FIGS. 1-9 wherein data is communicated between a web site system 120 and a web browser module 122, the features described above as performed by the web site system 120 and/or the web browser module 122 may be implemented in any combination of software and/or hardware. For example, the features described above as performed by the web browser module 122 and/or the web site system 120 may be performed, mutatis mutandis, by one or more dedicated or special-purpose applications.

Although the examples provided above with reference to FIGS. 1-11 are described as being performed by a client device 110, the same methods may be performed by agent device 111.

Although examples are provided above with respect to businesses, business owners, and business insurance product, the features describe above with reference to FIGS. 1-11 are equally applicable, mutatis mutandis, to other contexts. For example, the features described above may be used for the communication of information related to and/or the selection of insurance products that are applicable to all types of insurance consumers, including individuals, businesses, non-profit entities, governmental entities, and/or any other types of insurance consumers. For example, the features described above may be used for communication of information related to and/or the selection of individual insurance products, and/or any other insurance products. Alternatively or additionally, the features described above may be used for the communication of information related to and/or the selection of financial products that are not insurance products, such as risk management services, bonds, retirement plans, savings plans, and/or group benefits plans.

When referred to herein, the term “computer-readable medium” broadly refers to and is not limited to a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVDs, or BD, or other device for electronic data storage.

As used herein, the term “processor” broadly refers to and is not limited to a single- or multi-core general purpose processor, a special purpose processor, a conventional processor, a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

Although features and elements are described above in particular combinations, each feature or element can be used alone or in any combination with the other features and elements. For example, each feature or element described above with reference to any one or any combination of FIGS. 1-11 may be used alone without the other features and elements or in various combinations with or without other features and elements described above with reference to any one or any combination of FIGS. 1-11. Sub-elements of the methods and features described above may be performed in any arbitrary order (including concurrently), in any combination or sub-combination.

What is claimed is:

1. A system for the generating automated underwriting and quoting information related to data breach related insurance coverages offered by an insurance company, the system comprising:
a memory device configured to store a determined risk associated with the storage of confidential personal data, wherein the risk is based on at least the number of records stored by a business;
a processor, operably coupled to the memory device, configured to generate a plurality of underwriting questions, the questions including information concerning total revenue of the business;
a receiver configured to receive a response to the plurality of underwriting questions from the user device and to store the response to the plurality of underwriting questions in the memory device;
the processor further configured to determine an estimated exposure based at least in part on the determined risk and the response to the plurality of underwriting questions;
the processor further configured to determine, based on the estimated exposure and the response to the at least one underwriting question, at least one insurance product and at least one coverage option applicable to the business; and
a transmitter configured to transmit information associated with the at least one insurance product to the user device.

2. The system of claim 1, wherein the memory device is further configured to store data breach information, the data breach information including at least one of:
state regulations, federal regulations, and fine assessments.

3. The system of claim 2, wherein the determined risk is based on at least two or more of: state regulations, fine assessments, historical breach data, and type of business.

4. The system of claim 2, wherein the estimated exposure is based on at least two or more of: state regulations, fine assessments, historical breach data, and type of business.

5. The system of claim 1, wherein the determined risk associated with the storage of confidential personal data is generated by a third party.

6. The system of claim 1, wherein the determined risk associated with the storage of confidential personal data is calculated on a per record basis.

7. The system of claim 1, wherein the at least one coverage option includes at least one of: data privacy liability coverage, network security liability coverage, e-media liability coverage, notification expense and credit monitoring expense, crisis management expense, data privacy and regulatory expense, and cyber investigation expense.

8. The system of claim 1, wherein the processor is further configured to generate a quote associated with the at least one insurance product.

9. The system of claim 8, wherein the quote is a binding quote.

10. A method for the generating automated underwriting and quoting information related to data breach related insurance coverages offered by an insurance company, the method comprising:
storing, by a memory device, a determined risk associated with the storage of confidential personal data, wherein the risk is based on at least the number of records stored by a business;
generating, by a processor, a plurality of underwriting questions, the questions including information concerning total revenue of the business;
receiving, by a receiver, a response to the plurality of underwriting questions from the user device and to store the response to the plurality of underwriting questions in the memory device;
determining, by the processor, an estimated exposure based at least in part on the determined risk and the response to the plurality of underwriting questions;
determining, by the processor, based on the estimated exposure and the response to the at least one underwriting question, at least one insurance product and at least one coverage option applicable to the business; and
transmitting, by a transmitter, information associated with the at least one insurance product to the user device.

11. The method of claim 10, further comprising storing, by the memory device, data breach information, the data breach information including at least one of:
state regulations, federal regulations, and fine assessments.

12. The method of claim 11, wherein the determined risk is based on at least two or more of: state regulations, fine assessments, historical breach data, and type of business.

13. The method of claim 11, wherein the estimated exposure is based on at least two or more of: state regulations, fine assessments, historical breach data, and type of business.

14. The method of claim 10, wherein the determined risk associated with the storage of confidential personal data is generated by a third party.

15. The method of claim 10, wherein the determined risk associated with the storage of confidential personal data is calculated on a per record basis.

16. The method of claim 10, wherein the at least one coverage option includes at least one of: data privacy liability coverage, network security liability coverage, e-media liability coverage, notification expense and credit monitoring expense, crisis management expense, data privacy and regulatory expense, and cyber investigation expense.

17. The method of claim 10, further comprising generating, by the processor, a quote associated with the at least one insurance product.

18. The method of claim 8, wherein the quote is a binding quote.

19. A computer-readable medium having processor-executable instructions stored thereon which, when executed by at least one processor, will cause the at least one processor to perform a method for generating automated underwriting and quoting information related to data breach related insurance coverages offered by an insurance company, the method comprising:
storing a determined risk associated with the storage of confidential personal data, wherein the risk is based on at least the number of records stored by a business;
generating a plurality of underwriting questions, the questions including information concerning total revenue of the business;
receiving a response to the plurality of underwriting questions from the user device and to store the response to the plurality of underwriting questions in the memory device;
determining an estimated exposure based at least in part on the determined risk and the response to the plurality of underwriting questions;
determining, based on the estimated exposure and the response to the at least one underwriting question, at least one insurance product and at least one coverage option applicable to the business; and
outputting, information associated with the at least one insurance product to the user device.

20. The computer-readable medium of claim 19, wherein the determined risk associated with the storage of confidential personal data is generated by a third party.
